(19) United States
(12) Patent Application Publication
(10) Pub. No.: US 2019/0177190 A1
(43) Pub. Date: Jun. 13, 2019

(54) ANTI-MICROBIAL MEDIA AND METHOD OF MAKING THE SAME

(71) Applicant: Marmon Water (Singapore) Pte. Ltd., Singapore (SG)

(72) Inventors: Ramachandra Swamy, Bangalore (IN); Kritika Urmaliya, Bangalore (IN); Sridhar Chowdasandra, Chikkaballapura (IN); Jola Solomon, Bangalore (IN)

(21) Appl. No.: 16/213,302

(22) Filed: Dec. 7, 2018

Related U.S. Application Data
(60) Provisional application No. 62/618,878, filed on Jan. 18, 2018.

(30) Foreign Application Priority Data
Dec. 7, 2017 (IN) 201721044004

(51) Int. Cl. C02F 1/50; C02F 1/28; B01J 20/20; B01J 20/30; B01J 20/32; B01J 20/28; B01J 20/02

(52) U.S. Cl. CPC C02F 1/505; C02F 1/283; B01J 20/20; B01J 20/3085; B01J 20/3204; B01J 20/3236; C02F 2303/20; B01J 20/3293; B01J 20/0237; B01J 20/0244; B01J 20/3295; C02F 2305/08; C02F 2303/04; B01J 20/28016

(57) ABSTRACT

A water filtration media which prevents or resists the accumulation of microbes while simultaneously addressing the added problem of leaching caused by the treatment of activated carbon. In one preferred embodiment, the combination of Cu and Ag on activated carbon is prepared. Steps are taken to bind the silver and copper using anionic surfactant so that there is less leaching of silver and copper from the media. In a separate embodiment, the combination of Cu and Zn is prepared, which is subjected to high temperature for better binding of the metal oxides with the carbon.

### BACKGROUND OF THE INVENTION

### 1. Field of the Invention

The present invention relates to a water filtration media which inhibits the accumulation of microbes and addresses the added problem of leaching caused by the treatment of activated carbon. A bacteriostatic filter media, such as bacteriostatic carbon, is presented that employs multiple oxide impregnated activated carbon with antimicrobial properties.

### 2. Description of Related Art

As the quality of water supplies decline due to increased man-made contaminants, the need to purify the water for drinking at the point of consumption, such as the home, is also dramatically increasing. Because of the types of contaminants found in today's water supply, such as pesticides, fertilizers, chemical solvents, bacteria, heavy metals, and the like, one of the most effective ways of removing the same is by adsorbing or absorbing the contaminant by use of a filtration media through which the water is passed. Typical filtration media for water filtration are made of activated carbonaceous material. Such activated carbon may be used to remove bacterial and microbial contamination from the water.

Activated carbon is commonly used in filters to remove unpleasant taste, odors, and organic compounds from water along with chlorines and chloramines. However, they can be heavily colonized by heterotrophic microorganisms, even when silver is added to the filter as a bacteriostatic agent.

A traditional method to prohibit bacteria growth in point-of-use (POU) and point-of-entry (POE) filters is by impregnating activated carbon with silver. Although the silver amount is minimal, there is always some health concerns about its ability to leach into the treated water. Studies have shown that nano-silver is toxic to human health. Silver is generally deposited onto the carbon granule of filter media to potentially inhibit the growth of bacteria on the surfaces of these carbon particles. Such filters tend to leach out trace levels of silver into the effluent water.

Current, existing products are based upon silver impregnation. This increases the expense of the product and also does not adequately address the leaching of the silver, which remains of great concern. There is also ban of silver in many countries for such applications. Thus, it is advantageous to use as little silver as possible, and perhaps no silver. Such a design would be cost effective.

Nanoparticles, such as silver, TiO₂, and zinc oxide (ZnO), have been shown in laboratory settings to be anti-bacterial for drinking water treatment and could be used in lieu of chemical disinfectants that can cause harmful by-products. Silver has historically been used for disinfection, and silver nanoparticles may be even more effective than bulk silver. Silver nanoparticles can inactivate microbial respiratory enzymes, increase cellular reactive oxygen species generation, and affect DNA replication. To this end, silver nanoparticles are being imbedded into paper and ceramic filters for their antimicrobial properties during water treatment.

However, the effects of ingested nanoparticles are still being investigated, but research indicates that there are adverse health effects from exposure to nanoparticles through in vitro and in vivo experiments. In laboratory experiments at the cellular level, exposure to nanoparticles has led to cell death, DNA damage, and increased reactive oxygen species. Due to their small size, nanoparticles can accumulate inside cells, and once inside, nanoparticles may release ions that can directly impact cell functioning.

Current technology suggests that several techniques may be used for removing the silver ion from drinking water including reverse osmosis and distillation. Point-of-use/point-of-entry (POU/POE) devices and systems currently on the market may differ widely in their effectiveness in treating specific contaminants, and performance may vary from application to application.

Other elements that may leach from activated carbon are of concern, such as arsenic, antimony, and heavy metals. For example, almost all commercially available activated carbon contains ppb levels of arsenic and antimony, originating from the natural composition of raw materials from which said activated carbon is produced. When directly contacted with the water, activated carbon may leach small fractions of arsenic and antimony in the form of soluble oxy-anions, at ppb levels. Albeit miniscule, in general, leaching is an undesirable trait of carbon water filters.

Similarly, while attempting to limit leaching of impurities, it still remains necessary to provide filter media capable of inhibiting the growth and proliferation of bacteria on activated carbon, especially carbon in the form of a solid block, or granular activated carbon (GAC).

It has been known for many years that the presence of metal ions can be deleterious to the growth and survival of microorganisms at high enough concentrations. However, it is not desirable to overcome the problem of microorganism contamination by introducing another problem, metal contamination of the potable water.

It is known that carbon is an excellent medium for the growth of waterborne bacteria. Once bacteria colonize an activated carbon water filter, they will actually introduce more bacteria into the effluent than the water entering the filter, often introducing the very impurities that filters are intended to remove.

When bacteria colonize a water filter, they produce a slimy biofilm—an aggregation of microorganisms and extracellular proteins, DNA, and sugars secreted from the cells—that coats the carbon. The biofilm reduces the activated carbon's adsorptive capacity, so it filters the water less effectively. Additionally, biofilm can actually slough off the filter, producing unpleasant tastes, odors, and particulate matter in effluent that will ultimately be consumed as drinking water, ice, or a prepared beverage, like soda, or coffee.

### SUMMARY OF THE INVENTION

Bearing in mind the problems and deficiencies of the prior art, it is therefore an object of the present invention to provide a filter media that is capable of inhibiting the growth and proliferation of bacteria on activated carbon in the form of solid block/GAC.

One such method employs multiple oxide impregnated activated carbon with antimicrobial properties, such as the combination of Cu/Ag oxides or the combination of Cu/Zn oxides on, within, or both, activated carbon.

It is another object of the present invention to provide a bacteriostatic reduction media using low cost and silver-less alternatives like copper and zinc.

The above and other objects, which will be apparent to those skilled in the art, are achieved in the present invention which is directed to a method of preparing carbon as a filter media, comprising: performing an acid treatment on a base carbon material, including: soaking the base carbon with a weak tribasic acid like citric acid, orthophosphoric acid, orthoboric acid, humic acid, oxalic acid, and the like; decanting excess water from the soaked carbon; and drying the soaked carbon to form a resultant surface oxidized carbon; performing metal impregnation of the resultant surface oxidized carbon, including: dissolving salts of copper and salts of silver in water; dispersing the copper and silver particles in the water by adding a stabilizing agent to form a metal solution; mixing the metal solution homogenously; reducing the metal solution by adding a reducing agent to render a reduced metal solution; stirring the resultant surface oxidized carbon with the reduced metal solution to obtain a suspension of uniform mixture; filtering and washing the suspension to remove unbounded copper and silver to form a resultant impregnated mixture; drying the impregnated mixture to form copper and silver impregnated activated carbon; and cooling the copper and silver impregnated activated carbon at room temperature.

The base carbon material is granular activated carbon, and the granular activated carbon is preferably coconut-based carbon.

The base carbon is prepared having a moisture content less than 5% and an iodine number of greater than 1000 mg/g.

The weak tribasic like citric acid, orthophosphoric acid, orthoboric acid, humic acid, oxalic acid, etc., is introduced at a strength of 0.1-2.0 wt. %, and the soaking occurs for approximately one (1) hour.

Drying the soaked carbon is performed at a temperature of about 90° C.-120° C.

The step of dissolving copper and silver in water includes introducing copper in the form of water-soluble salts of copper like sulfate, nitrate, acetate, chloride, etc., and silver in the form of water-soluble salts of silver like nitrate, acetate, etc.

The salts of copper is preferably introduced in the range of 0.01-3% (w/w). The salt of silver is preferably introduced in the range of 0.01-1.5% (w/w).

The stabilizing agent is an anionic surfactant. Examples of anionic surfactant group includes sodium dodecyl sulfate (SDS), linear alkylbenzene sulfonates, di-alkyl sulfosuccinate (sulfonic acid salt), sodium lauryl sulfate (alcohol sulfate), phosphoric acid esters, sodium stearate (carboxylic acid salt). The stabilizing agent is added in the range of 0.01-0.5% (w/w).

The reducing agent is preferably hydrazine hydrate or sodium borohydride, or trisodium citrate, and is added in the range of 0.005-0.05% (w/w).

The step of drying the impregnated mixture is performed at a temperature of about 90-120° C. for period of approximately 4 hours until moisture content of the impregnated mixture is less than approximately 2%.

In a second aspect, the present invention is directed to a method of preparing carbon as a filter media, comprising: performing an acid treatment on a base carbon material, including: soaking the base carbon with a weak tribasic acid like citric acid, orthophosphoric acid, orthoboric acid, humic acid, oxalic acid, etc.; decanting excess water from the soaked carbon; and drying the soaked carbon to form a resultant surface oxidized carbon; performing metal impregnation of copper and zinc to the resultant surface oxidized carbon, including: dissolving salts of copper and salts of zinc in de-ionized water; mixing the metal solution homogenously; reducing the metal solution to render a reduced metal solution; stirring the resultant surface oxidized carbon with the reduced metal solution to obtain a suspension of uniform mixture; filtering and washing the suspension to remove unbounded copper and zinc to form a resultant impregnated mixture; drying the impregnated mixture to form copper and zinc impregnated carbon; high-temperature calcinating the copper and zinc impregnated carbon; and cooling the high-temperature calcined copper and zinc impregnated carbon at room temperature.

The base carbon material is preferably coconut-based, granular activated carbon.

The base carbon is prepared having a moisture content less than 5% and an iodine number of greater than 1000 mg/g.

The weak tribasic acid like citric acid, orthophosphoric acid, orthoboric acid, humic acid, oxalic acid, etc. is introduced at a strength of 0.1-2.0 wt. %, and the soaking occurs for approximately one (1) hour.

Drying the soaked carbon is preferably performed at a temperature of about 90° C.-120° C.

The water soluble salts of copper like sulfate, nitrate, acetate, chloride, etc., is preferably introduced in the range of 0.01-1.5% (w/w). The water-soluble salts of zinc like sulfate, acetate, chloride, etc., is preferably introduced in the range of 0.1-5% (w/w).

The suspension of uniform mixture has a solid to liquid ratio of about 1:2.

The step of high-temperature treating is established at a temperature of approximately 600° C. for 3 hours under inert atmosphere to form active sites on the surface of the carbon.

In a third aspect, the present invention is directed to a metal impregnated carbon-based filter media comprising: granular activated carbon; copper and silver nanoparticles impregnated within, on, or both within and on, the granular activated carbon.

In a fourth aspect, the present invention is directed to a metal impregnated carbon-based filter media comprising: granular activated carbon; and calcined copper and zinc nanoparticles impregnated within, on, or both within and on, the granular activated carbon by high temperature treatment.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a process chart for the preparation of granular activated carbon (GAC) of a first embodiment of the present invention using a wet process;

FIG. 2 depicts the combination of Cu²⁺ and Ag⁺ acid treated with reducing agent, H₂O, and introduced with an added stabilizer;

FIG. 3 illustrates the micelle formation of the anionic surfactant on the copper and silver;

FIG. 4 depicts a high temperature process for forming Copper and Zinc on a granular activated carbon material;

FIGS. 5A and 5B depict the log reduction value of the heterotrophic plate count for Samples 1 and 2 with the Cu/Ag formulation before and after stagnation as a function of the number of weeks tested, respectively;

FIGS. 6A and 6B depict the log reduction value of the heterotrophic plate count for the test sample with Cu/Zn formulation before and after stagnation as a function of the number of weeks tested, respectively;

FIGS. 7 and 8 depict a graphical presentation of the leaching data for copper and silver on the Cu/Ag treated activated carbon for two samples;

FIGS. 9 and 10 depict a graphical presentation of the leaching data for copper and Zinc on the Cu/Zn treated activated carbon;

FIG. 11 depicts a Scanning Electron Microscope (SEM) photograph of the base carbon, shown decorated with the Cu and Ag composite particles;

FIGS. 12 and 13 depict the EDS spectra of two selected areas from the SEM image;

FIG. 14 depicts an overlay of XRD patterns of regular activated carbon (Line A), oxidized activated carbon (Line B), EPC9 (Cu/Ag impregnated activated carbon) (Line C) and EPC9 (Cu/Zn impregnated activated carbon) (Line D);

FIG. 15 depicts the FTIR spectrum of regular activated coconut-shell carbon (coconut shell based); and

FIGS. 16 and 17 depict the FTIR spectrum of EPC9 Cu/Ag impregnated carbon, and EPC9 Cu/Zn impregnated carbon, respectively.

### DESCRIPTION OF THE EMBODIMENT(S)

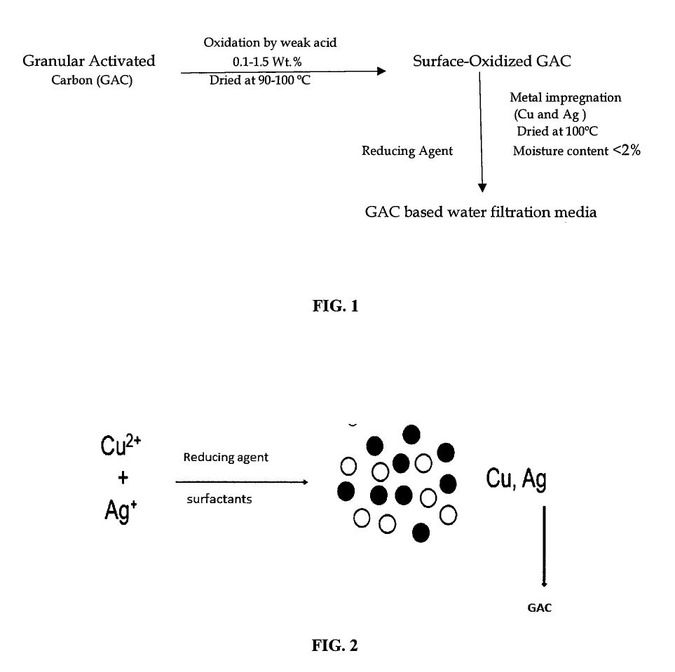

In describing the preferred embodiment of the present invention, reference will be made herein to FIGS. 1-17 of the drawings in which like numerals refer to like features of the invention.

The invention discloses methods of preparation of alternative media for a bacteriostatic carbon.

In one preferred embodiment, the combination of Cu and Ag on activated carbon is prepared. Steps are taken to bind the silver and copper using anionic surfactant so that there is less leaching of silver and copper from the media. In a separate embodiment, the combination of Cu and Zn is prepared, which is subjected to high temperature for better binding of the metal oxides with the carbon.

### Cu/Ag on Activated Carbon Preparation

FIG. 1 depicts a process chart for the preparation of granular activated carbon (GAC) of a first embodiment of the present invention using a wet process, or wet chemical formation, for producing GAC impregnated with copper and silver particles.

Granular activated carbon (preferably coconut based carbon) with moisture less than 5% and iodine number of greater than 1000 mg/g is used as the preferred base material, although other types of GAC may be employed without degradation of the resultant carbon subjected to this process, and the present invention is not limited to only GAC having this specific moisture content and iodine number.

An acid treatment is performed to enhance the surface oxygen groups. The activated carbon is soaked with weak tribasic acids (0.1-2%) for 1 hour. The excess water is decanted, and the carbon is dried. The drying process was carried out using a tunnel drier at about 90° C.-120° C. The resultant product is a surface oxidized GAC that has more active sites for the metal/metal oxide bonding.

The surface oxidized GAC is then processed. A metal impregnation step is initiated. Copper and silver are dissolved in water. Preferably, the salts of copper is introduced in the range of 0.01-3% (w/w), and the salts of silver is introduced in the range of 0.01-1.5% (w/w), although the present invention is not limited to these specific ranges, as the introduction of copper and/or silver to the GAC can be a value outside the preferred range.

These metals are dissolved in water having a stabilizing agent. Anionic surfactants like sodium dodecyl sulfate (SDS), linear alkylbenzene sulfonates, di-alkyl sulfosuccinate (sulfonic acid salt), sodium lauryl sulfate (alcohol sulfate), phosphoric acid esters, sodium stearate (carboxylic acid salt) were presented in the range of 0.01-0.5% (w/w). The solution is mixed homogenously. The solution is then reduced by using reducing agents like hydrazine hydrate. Hydrazine hydrate is used in industry as a reducing agent, a corrosion inhibitor, an oxygen scavenger, or as an intermediate of synthesis. Hydrazine hydrate is widely used as a reducing agent or an intermediate of synthesis in water treatment (effluents, industrial boilers, and the like).

Salts of copper and silver, which may be administered in the form of Copper sulfate and silver nitrate are then used as precursors for the impregnation.

The acid treated activated carbon powder is stirred thoroughly with the above mixture in solution to obtain a uniform mixture. The solid to liquid ratio of the mixture is preferably about 1:2, and the suspension temperature is approximately room temperature.

After about one hour of constant stirring, the suspension is filtered and washed with deionized water to remove unbounded copper and silver. The impregnated mixture is then dried, preferably at a temperature at about 90-120° C. for period of approximately 4 hours until the moisture is less than approximately 2%.

The copper and silver impregnated activated carbon is subsequently cooled to room temperature, and at this time, may be tested for its efficiency in terms of bacteriostatic removal capacity.

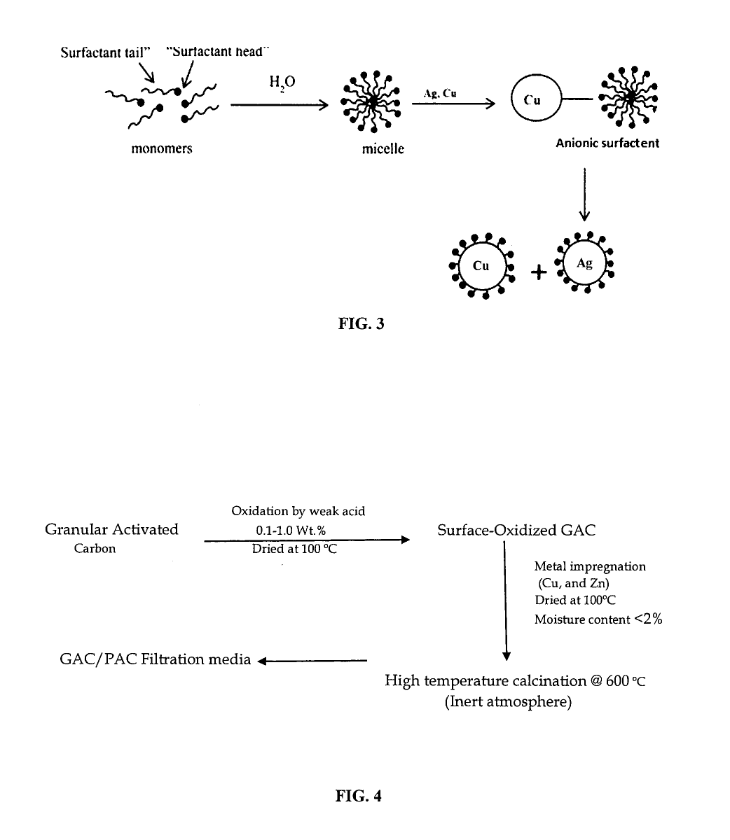

A wet-chemical formation of the silver and copper nanoparticles is illustrated in FIGS. 2 and 3. FIG. 2 depicts the combination of Cu²⁺ and Ag⁺ acid treated with reducing agent, H₂O, and introduced with an added stabilizer. The copper and silver nanoparticles are formed on, within, or both on and within, the GAC.

FIG. 3 illustrates the micelle formation of the anionic surfactant on the copper and silver ions. A micelle is an aggregate of surfactant molecules dispersed in a liquid colloid. A typical micelle in aqueous solution forms an aggregate with the hydrophilic “head” regions (in this instance, a surfactant head) in contact with surrounding solvent, sequestering the hydrophobic single-tail regions in the micelle center (in this instance, a surfactant tail). In a micelle, the hydrophobic tails flock to the interior in order to minimize their contact with water, and the hydrophilic heads remain on the outer surface in order to maximize their contact with water.

This surfactant micelle, when added to the impregnate solution, helps in dispersing the Cu and Ag ions in water (before impregnation process). The anionic surfactant is typically added so that the Cu and Ag ions are dispersed well to achieve a better impregnation and better dispersion of the adsorptive sites. As depicted in FIG. 3, the micelles form on the copper and silver to provide resultant copper and silver covered with the surfactant micelle with surfactant heads extending away from the copper and silver respectively.

In the present case, it has been observed and shown that the addition of an anionic surfactant, helps in reducing Cu and Ag leaching. This unexpected advantage occurs in part as a result of better binding of the metal oxides on the carbon surface due to the stabilizer addition.

As noted above, surfactants are amphiphilic molecules composed of a hydrophilic moiety known as “head” and hydrophobic moiety known as “tail”. A surfactant, when present at low concentrations in a system, adsorbs onto surfaces or interfaces mostly reducing the interfacial free energy. When surfactant molecules are dissolved in water at concentrations above the critical micelle concentration, they form aggregates known as micelles. FIG. 3 graphically depicts the formation and adherence of the aggregates or micelles on copper and silver.

### Cu/Zn on Activated Carbon Preparation

FIG. 4 depicts a high temperature process for forming Copper and Zinc on a granular activated carbon material.

Fresh activated carbon with moisture less than 5% and iodine of greater than 1000 mg/g is used as the base material, although other types of activated carbon may be employed without degradation of the resultant carbon subjected to this process, and the present invention is not limited to only activated carbon having this specific moisture content and iodine number.

An acid treatment step (orthophosphoric oxidation) is first performed. The activated carbon is preferably soaked with a weak tribasic acid (0.1-2%) for 1 hour. The excess water is decanted, and the carbon is dried using a tunnel drier, preferably at temperature at about or less than 90-120° C. This step is carried to provide more active sites for the metal/metal oxide bonding.

Next, the impregnation step is performed. Salts of Copper and salts of Zinc are dissolved in deionized water. Preferably, the copper is introduced at an amount of about 0.01-1.5% (w/w), and the zinc is introduced at an amount of about 0.1-5% (w/w). The solution is then mixed homogenously.

The acid treated activated carbon powder is stirred thoroughly with the above mixture in solution to obtain a uniform mixture. The solid to liquid ratio of the mixture is preferably about 1:2, and the suspension temperature is approximately room temperature.

After about one hour of constant stirring, the suspension is filtered and washed with deionized water to remove unbounded copper and zinc. The impregnated mixture is then dried, preferably at a temperature at about 90-120° C. for period of approximately 4 hours until the moisture is less than approximately 2%.

The resultant is then high-temperature treated by calcinating (calcined). The copper and zinc impregnated activated carbon is calcined for better binding of the metal oxides with the carbon, which is preferably established at a temperature of approximately 400-700° C., and preferably 600° C., for 3 hours under inert atmosphere using nitrogen to form active sites on the surface of the carbon. The calcined impregnated carbon is then cooled to room temperature and tested for its efficiency in terms of bacteriostatic removal capacity.

Performance efficiency data and the leaching studies are demonstrated below.

### Test for Determination of Bacteriostatic Reduction Capacity

The media was tested for bacteriostatic reduction claim as per the NSF/ANSI 42-2017 protocol. The cartridges containing the media of the invention were tested for five days followed by a 56-hour stagnation period. The test was conducted for 13 weeks. The predetermined acceptable limit assigned was to have the geometric mean of the heterotrophic plate counts of the effluent be no greater than ±20% of the influent challenge.

The test water conditions were as follows:

Heterotrophic Bacteria (Bacteria count)−(1−6.5 log heterotrophic plate count)

TDS: 200-600 ppm

pH: 7.5±0.5

Temperature: 20+/−0.3° C.

Total residual Chlorine: <0.2 ppm

TOC: ≥2 ppm

Run cycle: 1 min on and 59 min off cycle

A cartridge containing the treated carbon media was tested for bacteriostatic effect in accordance to NSF/ANSI-42-2015. The media was challenged for 16 hours per day with a 1-minute on/59-minute off cycle followed by an 8-hour stagnation period every day for five days. A 56-hour stagnation period followed five days of operation. The test was conducted for 13 weeks.

A sampling plan was initiated. One hundred (100) ml of the input water and one hundred (100) ml of product water was collected from the units in the following time intervals: a) at the start of the test; b) after the initial eight (8) hours of operation; c) before the 56-hour stagnation period begins each week; and d) after the 56-hour stagnation period ends each week.

Analysis of the samples commenced with the collection of about 100 ml of the sample, and analyzed as per APHA 21^{st} Edition (Method 9215 D) to enumerate the total heterotrophic plate count by Membrane filtration techniques on R2A agar. The plates were incubated for five days at 28° C. then enumerated.

The microbiological test results on the performance of Cu/Ag are depicted in Table I.

TABLE I
(Performance Data of Cu/Ag Sample)

| | Input | | Sample 1 | | Sample 2 | |
|---|---|---|---|---|---|---|
| | Before | After | Before | After | Before | After |
| | stag- | stag- | stag- | stag- | stag- | stag- |
| Week | nation | nation | nation | nation | nation | nation |
| 1st week | 5.71 | 5.78 | 5.29 | 5.31 | 5.19 | 5.36 |
| 2nd week | 5.61 | 5.72 | 5.49 | 5.52 | 5.44 | 5.56 |
| 3rd week | 5.58 | 5.79 | 5.38 | 5.61 | 5.3 | 5.69 |
| 4th week | 5.39 | 5.41 | 5.29 | 5.36 | 5.21 | 5.4 |
| 5th week | 5.5 | 5.71 | 5.46 | 5.6 | 5.51 | 5.71 |
| 6th week | 5.3 | 4.92 | 5.06 | 4.04 | 5.01 | 4.06 |
| 7th week | 4.98 | 5.12 | 4.47 | 4.25 | 4.39 | 4.19 |
| 8th week | 5.72 | 5.51 | 5.01 | 4.91 | 5.09 | 4.96 |
| 9th week | 5.7 | 5.08 | 5.13 | 5.02 | 5.18 | 5.02 |
| 10th week | 5.42 | 5.23 | 5.02 | 4.87 | 5.06 | 4.86 |
| 11th week | 4.94 | 4.7 | 4.55 | 4.69 | 4.59 | 4.68 |
| 12th week | 4.83 | 4.92 | 4.39 | 4.41 | 4.43 | 4.43 |
| 13th week | 5.06 | 5.09 | 4.5 | 4.47 | 4.52 | 4.41 |
| GEOMEAN | 5.36 | 5.29 | 4.99 | 4.90 | 4.98 | 4.92 |

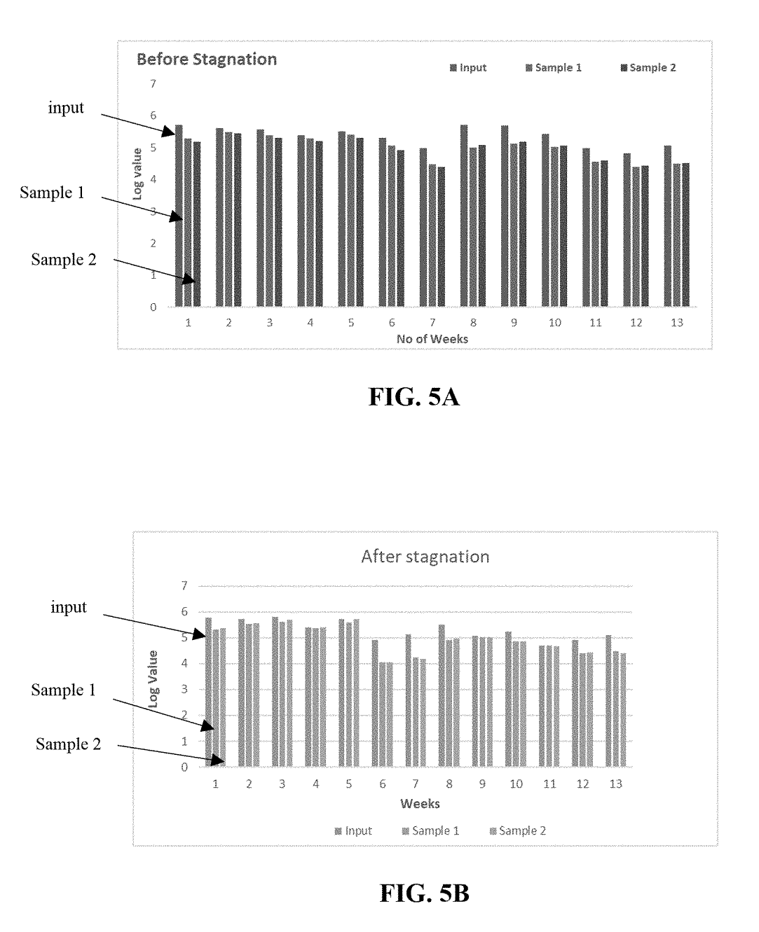

The log reduction value for Samples 1 and 2 of the heterotrophic plate count before and after stagnation as a function of the number of weeks tested are given by the graphs illustrated in FIGS. 5A and 5B, respectively.

The microbiological test results on the performance of Copper/Zinc sample (Cu/Zn) are depicted in Table II.

TABLE II
(Performance data of Cu/Zn)

| | |
|---|---|
| Input | Treated Carbon |

| | Before | After | Before | After |
|---|---|---|---|---|
| Week | stagnation | stagnation | stagnation | stagnation |
| 1st week | 5.42 | 5.69 | 4.89 | 4.91 |
| 2nd week | 5.01 | 4.74 | 4.9 | 4.38 |
| 3rd week | 5.14 | 5.07 | 4.98 | 4.74 |
| 4th week | 5.72 | 5.51 | 5.01 | 4.2 |
| 5th week | 5.2 | 4.7 | 5.01 | 4.21 |
| 6th week | 5 | 4.82 | 4.75 | 4.7 |
| 7th week | 4.81 | 4.51 | 4.39 | 4.27 |
| 8th week | 4.92 | 4.86 | 4.52 | 4.36 |
| 9th week | 5.06 | 5.09 | 4.86 | 4.91 |
| 10th week | 4.87 | 4.65 | 4.75 | 4.59 |
| 11th week | 5.47 | 4.61 | 5.24 | 4.54 |
| 12th week | 4.94 | 4.89 | 4.77 | 4.76 |
| 13th week | 4.59 | 4.78 | 4.47 | 4.7 |
| Geomean | 5.08 | 4.91 | 4.81 | 4.55 |

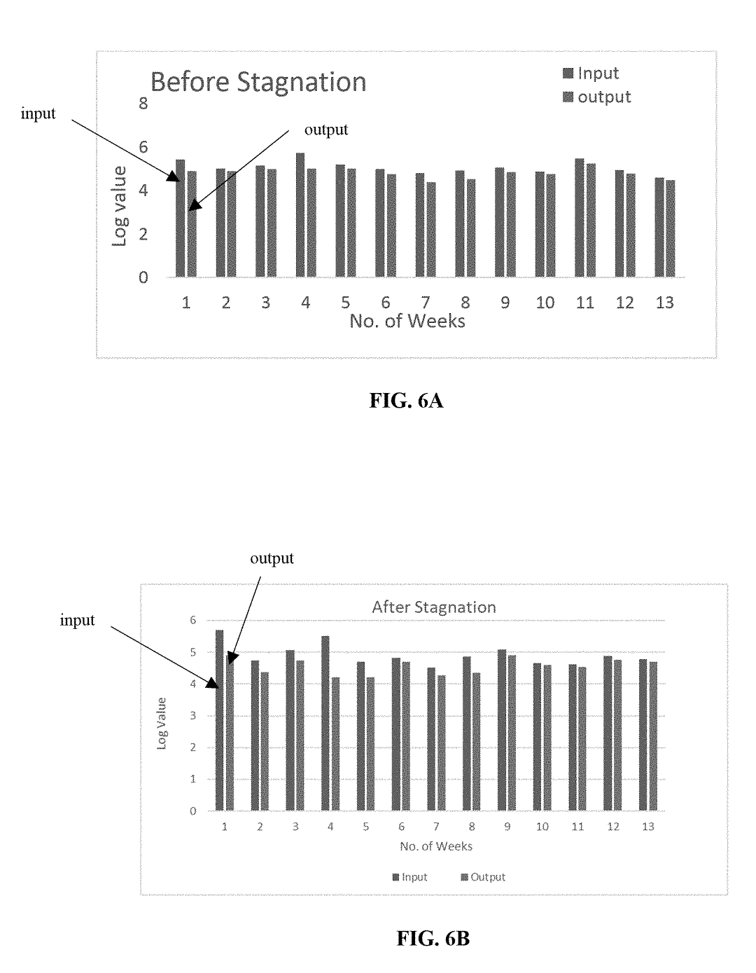

The log reduction value of the heterotrophic plate count for the test sample before and after stagnation as a function of the number of weeks tested are illustrated in FIGS. 6A and 6B, respectively.

### Results on Leaching

Extraction studies for the Cu/Ag treated activated carbon samples were then performed. The cartridges with the modified formulations were tested up to 100 L and the effluent samples were collected for every 10 L and analyzed using AAS (Perkin Elmer, Pinnacle 900T) for Cu and Ag concentrations.

The extraction studies were also carried out as per the NSF protocol (NSF 42 sec 4.2). The cartridges were exposed to test water with a TDS of 50±5 ppm; free chlorine of 0.5±0.05 ppm; and pH of 6.75±0.25. The cartridges were refilled with the exposure water and maintained for 24 hours. Water samples were collected, the cartridges were then flushed, refilled, and maintained for another 24 hour exposure. The process was repeated for an additional 24 hours. The samples were then composited and analyzed.

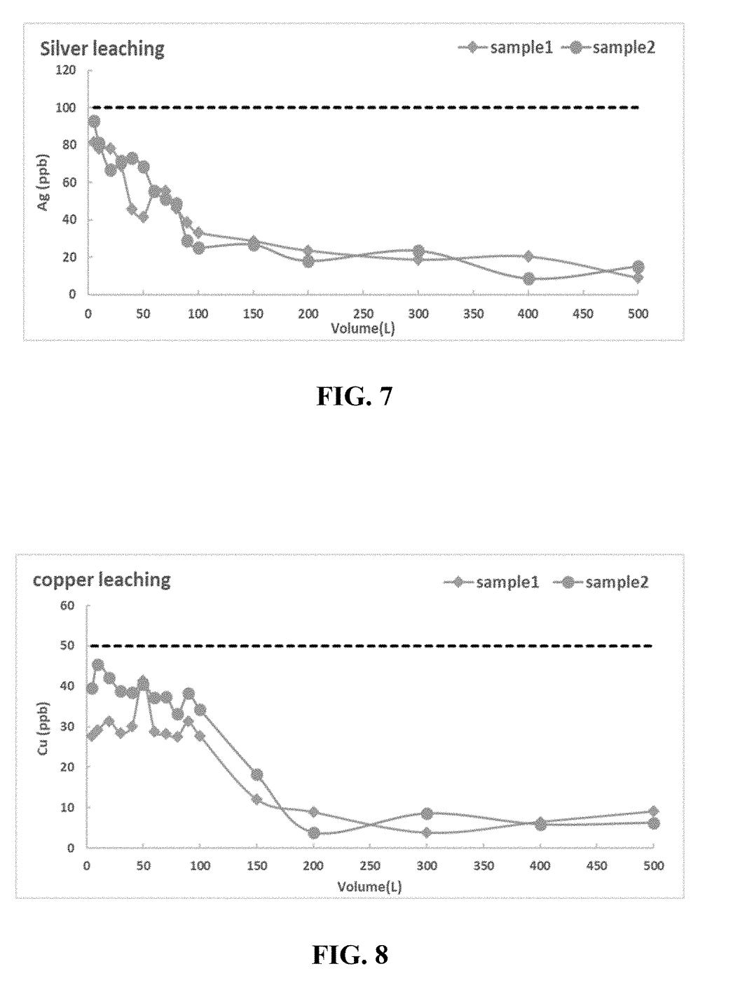

FIGS. 7 and 8 depict a graphical presentation of the leaching data for copper and silver on the Cu/Ag treated activated carbon for two samples.

The quantitative results of Cu and Ag extraction as per NSF 42 are depicted in Table III below:

TABLE III
Cu/Ag Leaching Sample Measurements

| | Sample 1 | Sample 2 | Sample 1 | Sample 2 |
|---|---|---|---|---|
| | Cu (ppb) | Cu (ppb) | Ag (ppb) | Ag (ppb) |
| 24 Hour | 68.8 | 72.4 | 116.4 | 105.9 |
| 48 Hour | 25.1 | 21.2 | 62.9 | 82.6 |
| 72 Hour | 22.6 | 18.6 | 51.3 | 52.1 |
| Composite | 39.6 | 38.3 | 73.2 | 81.2 |

### Leaching Data—Cu/Zn on Activated Carbon

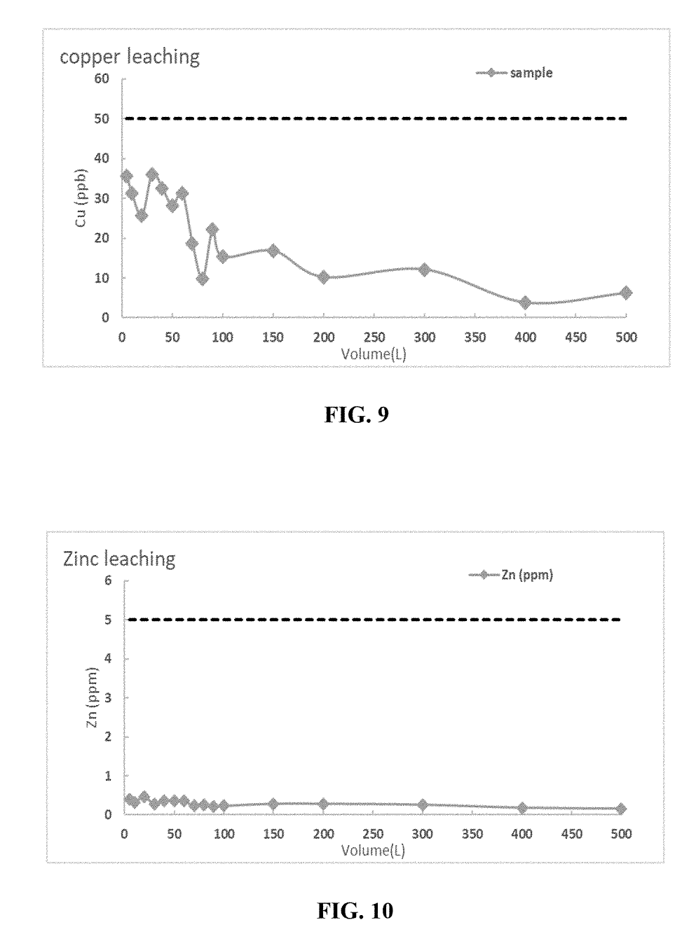

FIGS. 9 and 10 depict a graphical presentation of the leaching data for copper and Zinc on the Cu/Zn treated activated carbon.

The quantitative results of Cu and Zn extraction as per NSF 42 over time are depicted in Table IV below:

TABLE IV
Cu/Zn LEACHING SAMPLE MEASUREMENTS

| | Cu (ppb) | Zn (ppb) |
|---|---|---|
| 24 Hour | 61.8 | 178.3 |
| 48 Hour | 31.1 | 111.3 |
| 72 Hour | 21.3 | 145.3 |
| Composite | 38.8 | 145.2 |

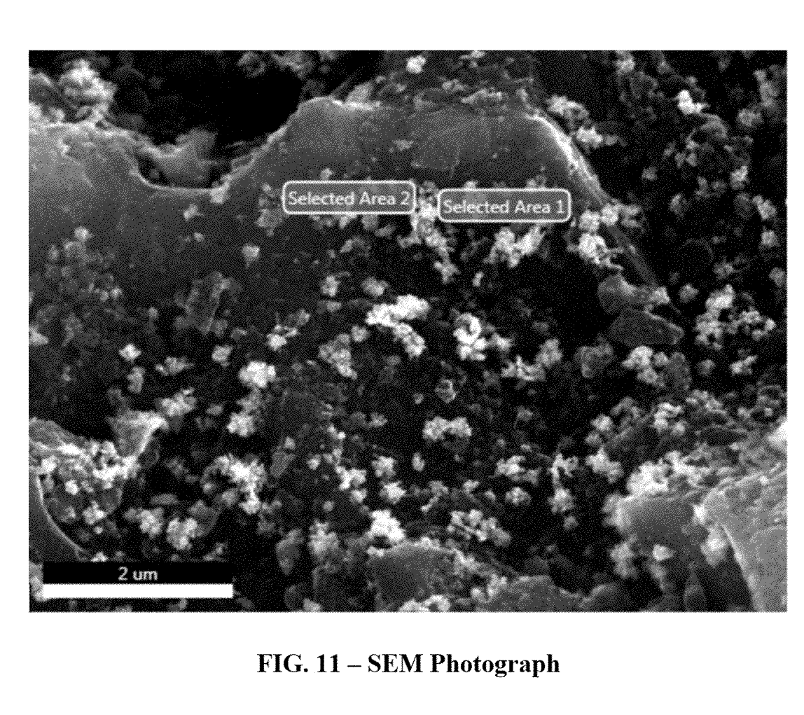

FIG. 11 depicts a Scanning Electron Microscope (SEM) photograph of the base carbon, shown decorated with the Cu and Ag composite particles. The SEM typically gives information about the sample's surface topography. An Energy Dispersive X-ray Spectroscopy (EDAX) is used for the elemental analysis of the sample. Two areas, Selected Areas 1 and 2, identified in the SEM Photograph were further analyzed for elemental analysis by the EDAX.

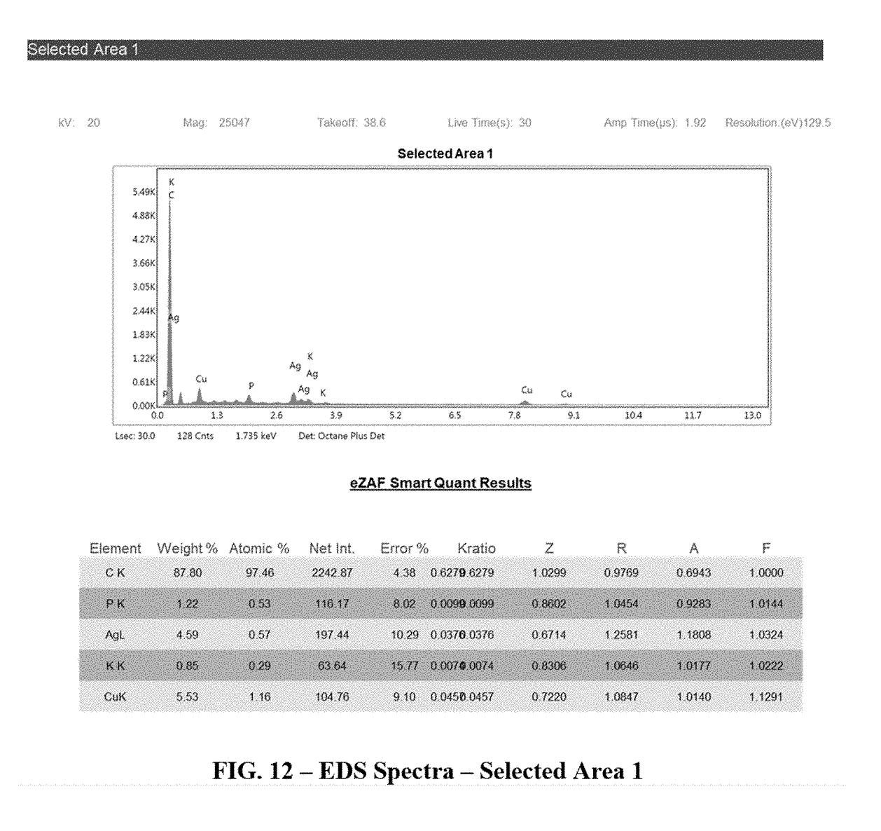

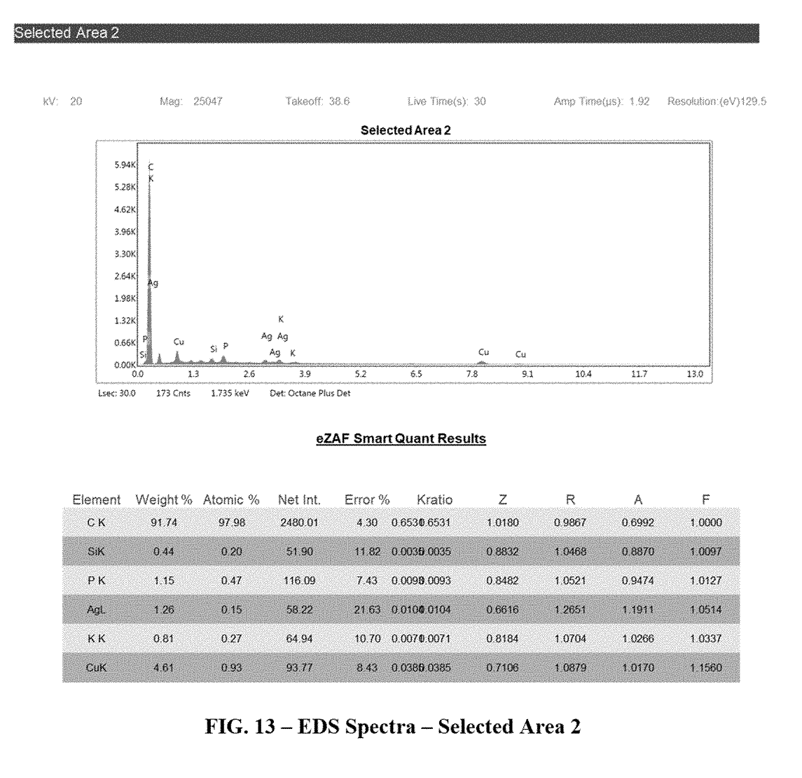

The two selected area present different EDS Spectra as shown in FIGS. 12 and 13.

As the results depict, the metal oxides are bound much stronger to the carbon matrix by the anionic surfactant and/or high temperature calcinations. This results in significantly less leaching.

### X-Ray Diffraction Analysis

X-Ray Diffraction Analysis (XRD) was carried out to identify structural changes between regular activated carbon (coconut-shell based), oxidized activated carbon, and the impregnated carbons of the present invention (referred in the graphs as EPC9 Cu/Ag and EPC9 Cu/Zn).

Samples were ground with a mortar and pestle and passed through a 200-mesh sieve (74-μm nominal opening size). Samples were then loaded on a low-background plate for XRD measurements.

XRD patterns were acquired using a Bruker D2 Phaser equipped with a high-speed linear detector (LYNXEYE) and Cu K-alpha radiation (1.54184 Å) at 30 kV and 10 mA. The measurements were performed over a 2-theta range of 5 to 135 deg, with a scan speed of 1 sec/step and 0.02 deg increments.

Identification of crystalline materials was conducted using the Bruker “Diffrac.Eva” search/match software and the ICDD PDF-2 database.

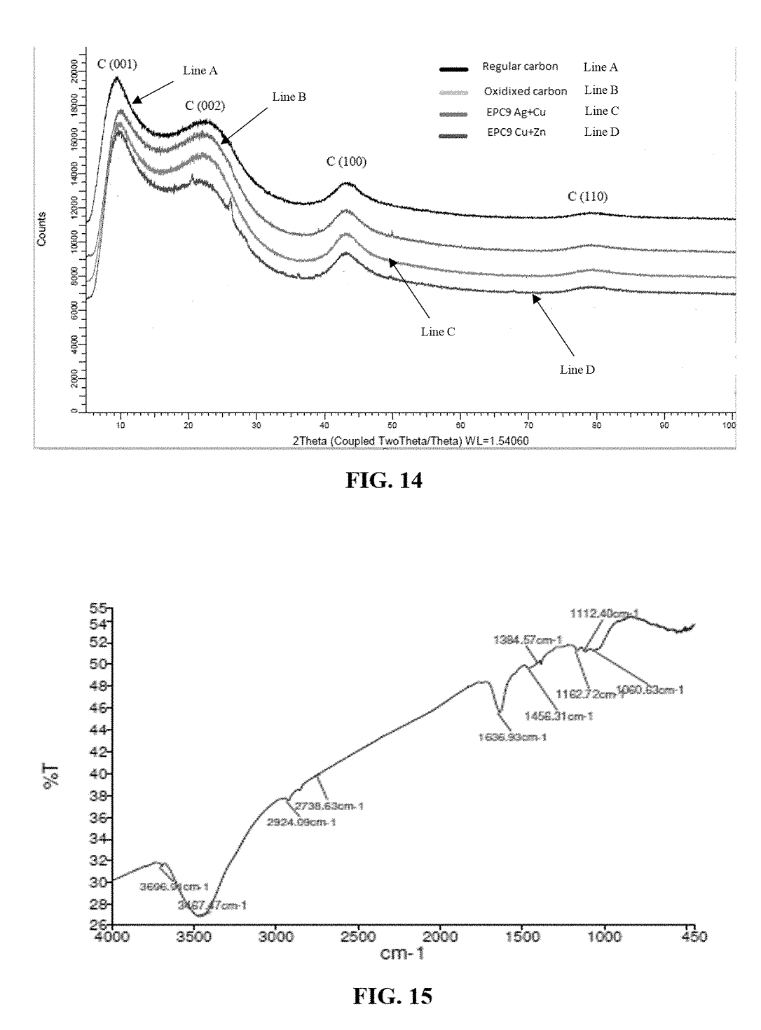

FIG. 14 depicts an overlay of XRD patterns of regular activated carbon (Line A), oxidized activated carbon (Line B), EPC9 (Cu/Ag impregnated activated carbon) (Line C) and EPC9 (Cu/Zn impregnated activated carbon) (Line D). For clarity, the patterns were shifted in intensity with respect to each other.

The peak center (2-theta), interplanar distance (d-spacing), and full width at half maximum (FWHM) for carbon peaks for regular activated carbon, oxidized activated carbon, and EPC9 (Cu/Ag & Cu/Zn impregnated activated carbon) were obtained by profile fitting of each sample, the results of which are summarized in Table V below:

TABLE V

| | C (001) | | | C (002) | | | C (100) | | |
|---|---|---|---|---|---|---|---|---|---|
| | | d- | | | d- | | | d- | |
| | 2-theta | spacing | FWHM | 2-theta | spacing | FWHM | 2-theta | spacing | FWHM |
| Sample | (deg) | (A°) | (deg) | (deg) | (A°) | (deg) | (deg) | (A°) | (deg) |
| Regular Activated | 8.784 | 10.067 | 4.458 | 23.710 | 3.753 | 5.541 | 42.841 | 2.111 | 3.560 |
| Carbon | | | | | | | | | |
| Oxidized Activated | 9.215 | 9.597 | 4.130 | 23.509 | 3.784 | 5.981 | 42.695 | 2.118 | 3.440 |
| Carbon | | | | | | | | | |
| EPC9 Cu/Ag | 9.043 | 9.779 | 4.317 | 23.503 | 3.785 | 5.783 | 42.719 | 2.117 | 3.585 |
| EPC9 Cu/Zn | 8.964 | 9.866 | 4.903 | 23.510 | 3.784 | 5.958 | 42.662 | 2.119 | 3.685 |

It was possible to identify very broad peaks of carbon for all three samples, namely regular activated carbon, oxidized activated carbon, and EPC9 (Cu/Ag & Cu/Zn impregnated activated carbon). These samples exhibit four broad peaks corresponding to the (001), (002), (100) and (111) Bragg reflections of Carbon. The background broad peaks at 20 values at approximately 9, 23.5, and 43 refer to the amorphous structure of the activated carbon. The XRD pattern of both EPC9 (Cu/Ag & Cu/Zn impregnated activated carbon) is very much similar to both coconut-shell based regular activated carbon. The oxidized activated carbon indicates that the overall structural integrity of regular activated carbon in the EPC9 Cu/Ag & Cu/Zn impregnated activated carbon remains the same before and after the modification except for small changes in the d-spacing for C (001) and C (002) reflection patterns.

### Fourier Transform Infrared (FTIR) Spectroscopy

FTIR is a well-known method for analyzing surface chemistry. It can be used to detect the functional groups present in the sample. IR Spectroscopy measures the vibrations of atoms and based on this it is possible to determine the functional groups. IR analysis involve the characterization of a material with respect to the presence or absence of a specific group's frequency associated with one or more fundamental modes of vibration. Here FTIR spectroscopic analysis is performed on coconut-shell based regular activated carbon, and surface modified (impregnated) activated carbon (EPC9 Cu/Ag & Cu/Zn) in order to identify the types of surface functional groups present in those sample.

In order to perform Fourier Transform Infrared Spectroscopy (FTIR—Perkin Elmer) on the surface functional groups, samples were initially prepared.

The carbon samples were mixed with KBr of spectroscopic grade and made as thin pellets using a hydraulic press at a pressure of 1 MPa. The pellets were about 10 mm in diameter and 1 mm in thickness. The pellet was placed in the IR beam for spectral analysis. The FTIR spectra of coconut-shell based regular activated carbon, Ag/Cu & Cu/Zn impregnated activated carbon (EPC9) were recorded between the spectral range of 4000 and 450 cm⁻¹.

FIG. 15 depicts the FTIR spectrum of regular activated coconut-shell carbon (coconut shell based).

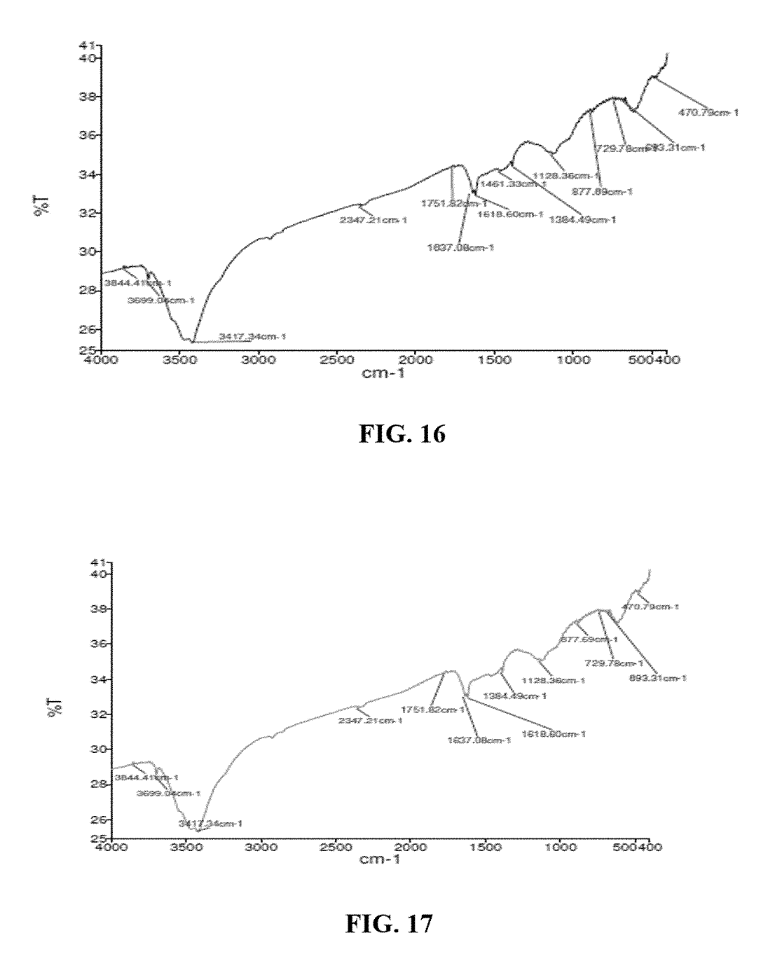

FIGS. 16 and 17 depict the FTIR spectrum of EPC9 Cu/Ag impregnated carbon, and EPC9 Cu/Zn impregnated carbon, respectively.

The FTIR Spectra depicts all the carbon samples having a wide band at about 3350-3470 cm⁻¹, typically assigned to the O—H stretching mode of hexagonal groups and adsorbed water. The weak band at approximately 3699-3696 cm⁻¹ can be attributed to isolated O—H groups. The regular carbon shows a peak at 2924 cm⁻¹ which represents absorption bands due to aliphatic C—H; however, this is absent in the impregnated carbons. The peaks at approximately 1751 cm⁻¹ in the impregnated carbons represents C═O bonds stretching vibrations of ketones, aldehydes, lactones, or carboxyl groups. The weak intensity of this peak indicates that the orthophosphoric acid treated carbons contain a small amount of carbonyl groups. The band around 1618, 1637, and 1636 cm⁻¹ represents aromatic C═C stretching vibrations enhanced by polar functional group. The bands at approximately 1060 cm⁻¹ and 1128 cm⁻¹ indicate the presence of different C—O stretching vibrations.

Table VI summarizes the IR assignments of functional groups on coconut-shell based activated carbon and EPC9 Ag/Cu and Cu/Zn modified carbon.

TABLE VI

| | | IR Peaks (cm⁻¹) | | |
|---|---|---|---|---|
| | | Coconut-shell | EPC9 Ag/Cu | EPC9 Cu/Zn |
| | | based regular | Impregnated | Impregnated |
| Functional Groups | Assignment | activated carbon | carbon | carbon |
| —OH | O—H stretching vibration | 3467 | 3417 | 3417 |
| —CH₂ | C—H asymmetric stretching | 2924 | — | — |
| | C—H symmetric stretching | 2738 | | |
| C═O | Stretching vibration of C═O | — | 1751 | 1751 |
| C═C | Stretching vibration of C═C | 1636 | 1618 | 1618 |
| | in aromatic rings | | 1637 | 1637 |
| C—O | Stretching of C—O | 1060 | 1128 | 1128 |
| | functional groups | | | |

Thus, as empirically demonstrated, the carbon of the present invention lends itself to water filtration media which prevents or resists the accumulation of microbes while simultaneously addressing the added problem of leaching caused by the treatment of activated carbon. The methods discussed above for preparing bacteriostatic filter media, such as bacteriostatic carbon, successfully employs multiple oxide impregnated activated carbon with antimicrobial properties.

While the present invention has been particularly described, in conjunction with a specific preferred embodiment, it is evident that many alternatives, modifications and variations will be apparent to those skilled in the art in light of the foregoing description. It is therefore contemplated that claims will embrace any such alternatives, modifications and variations as falling within the true scope and spirit of the present invention.

1. A method of preparing activated carbon as a filter media, comprising:
performing an acid treatment on a base carbon material, including:
soaking said base carbon with a weak tribasic acid, citric acid, orthophosphoric acid, orthoboric acid, humic acid, phosphoric acid, or oxalic acid;
decanting excess water from said soaked carbon; and
drying said soaked carbon to form a resultant surface oxidized carbon;
performing metal impregnation of said resultant surface oxidized carbon, including:
dissolving copper and silver in water;
dispersing said copper and silver in said water by adding a stabilizing agent to form a metal solution;
mixing said metal solution homogenously;
reducing said metal solution by adding a reducing agent to render a reduced metal solution;
stirring said resultant surface oxidized carbon with said reduced metal solution to obtain a suspension of uniform mixture;
filtering and washing said suspension to remove unbounded copper and silver to form a resultant impregnated mixture;
drying said impregnated mixture to form copper and silver impregnated activated carbon; and
cooling said copper and silver impregnated activated carbon at room temperature.

2. The method of claim 1, wherein said base carbon material is granular activated carbon.

3. The method of claim 2, wherein said granular activated carbon is coconut-based carbon, wood-based carbon, or coal-based carbon.

4. The method of claim 1, wherein said base carbon is prepared having a moisture content less than 5% and an iodine number of greater than 1000 mg/g.

5. The method of claim 1, wherein said acid is introduced at a strength of 0.1-2.0 wt. %, and said soaking occurs for approximately one (1) hour.

6. The method of claim 1, wherein drying said soaked carbon is performed at a temperature of about 90° C.-120° C.

7. The method of claim 1, wherein said step of dissolving copper and silver in water includes introducing copper in the form of water soluble salts of copper like sulfate, nitrate, acetate, or chloride, and silver in the form of form of water soluble salts of silver like nitrate, or acetate.

8. The method of claim 7, wherein said salts of copper is introduced in the range of 0.01-3% (w/w).

9. The method of claim 7, wherein said salts of silver is introduced in the range of 0.01-1.5% (w/w).

10. The method of claim 1, wherein said stabilizing agent is an anionic surfactant that forms micelle with surfactant heads extending away from the copper and silver.

11. The method of claim 10, wherein said stabilizing agent is selected from the group consisting of sodium dodecyl sulfate (SDS), linear alkylbenzene sulfonates, di-alkyl sulfosuccinate (sulfonic acid salt), sodium lauryl sulfate (alcohol sulfate), phosphoric acid esters, and sodium stearate (carboxylic acid salt).

12. The method of claim 1, wherein said stabilizing agent is added in the range of 0.01-0.5% (w/w).

13. The method of claim 1, wherein said reducing agent is hydrazine hydrate.

14. The method of claim 1, wherein said suspension of uniform mixture has a solid to liquid ratio of about 1:2.

15. The method of claim 1, wherein said step of filtering and washing is performed in deionized water.

16. The method of claim 1, wherein said step of drying said impregnated mixture is performed at a temperature of about 90-120° C. for a period of approximately 4 hours until moisture content of said impregnated mixture is less than approximately 2%.

17. A method of preparing carbon as a filter media, comprising:
performing an acid treatment on a base carbon material, including:
soaking said base carbon with a weak tribasic acid;
decanting excess water from said soaked carbon; and
drying said soaked carbon to form a resultant surface oxidized carbon;
performing metal impregnation of copper and zinc to said resultant surface oxidized carbon, including:
dissolving salts of copper and salts of zinc in deionized water;
mixing said metal solution homogenously;
reducing said metal solution to render a reduced metal solution;
stirring said resultant surface oxidized carbon with said reduced metal solution to obtain a suspension of uniform mixture;
filtering and washing said suspension to remove unbounded copper and zinc to form a resultant impregnated mixture;
drying said impregnated mixture to form copper and zinc impregnated carbon;
high-temperature calcinating said copper and zinc impregnated carbon; and
cooling said high-temperature calcined copper and zinc impregnated carbon at room temperature.

18. The method of claim 17, wherein said base carbon material is granular activated carbon.

19. The method of claim 18, wherein said granular activated carbon is coconut-based carbon, wood-based carbon, or coal-based carbon.

20. The method of claim 17, wherein said base carbon is prepared having a moisture content less than 5% and an iodine number of greater than 1000 mg/g.

21. The method of claim 17, wherein said weak tribasic acid in the form of phosphoric acid is introduced at a strength of 0.1-1.0 wt. % phosphoric acid, and said soaking occurs for approximately one (1) hour.

22. The method of claim 17, wherein drying said soaked carbon is performed at a temperature of about 90° C.-100° C.

23. The method of claim 17, wherein said salts of copper is introduced in the range of 0.01-1.5% (w/w).

24. The method of claim 17, wherein said salts of zinc is introduced in the range of 0.1-5% (w/w).

25. The method of claim 17, wherein said suspension of uniform mixture has a solid to liquid ratio of about 1:2.

26. The method of claim 17, wherein said impregnated mixture is dried at about 90-120° C. for period of approximately 4 hours until the moisture is less than approximately 2%.

27. The method of claim 17, wherein said high-temperature treating is established at a temperature of approximately 400-700° C. for 3 hours under inert atmosphere to form active sites on the surface of the carbon.

28. A metal impregnated carbon-based filter media comprising:
granular activated carbon; and
copper and silver nanoparticles impregnated within, on, or both within and on, said granular activated carbon.

29. A metal impregnated carbon-based filter media comprising:
granular activated carbon; and
calcined copper and zinc nanoparticles impregnated within, on, or both within and on, said granular activated carbon.
